(19) United States
(12) Patent Application Publication
(10) Pub. No.: US 2016/0289121 A1
(43) Pub. Date: Oct. 6, 2016

(54) HIGH STRENGTH CONCRETE COMPOSITION AND METHOD

(71) Applicant: John Andrew Coleman, Santa Rosa Beach, FL (US)

(72) Inventor: John Andrew Coleman, Santa Rosa Beach, FL (US)

(21) Appl. No.: 14/679,711

(22) Filed: Apr. 6, 2015

(51) Int. Cl. C04B 28/04; C04B 14/18

(52) U.S. Cl. CPC C04B 28/04; C04B 14/185

(57) ABSTRACT

A high strength concrete composition comprising cement, expanded perlite, aggregate, water in an amount corresponding to a water to cement ratio of about 0.25 to 0.35, and one or more chemical admixtures in an amount sufficient for workability. The composition exhibits typical compressive strengths in the range of about 10000 to about 14000 psi after 28 days. In addition, the composition exhibits extremely high heat resistance and low permeability. The composition is particularly suitable in applications such as runways and landing pads, anti-ballistic panels, and blast resistant walls, barriers, panels, and checkpoints. The enhanced strength allows lesser quantities of concrete to be used in the construction of highway, bridges, buildings, dams, and similar structures.

### FIELD OF THE INVENTION

A preferred embodiment of the invention is directed to a high strength, heat resistant concrete composition having low permeability and a method for making the composition.

### BACKGROUND

Concrete is an extremely important building material used in a wide variety of modern structures such as buildings, bridges, roads, and dams. Many different formulations of concrete have been developed depending on the desired properties of the concrete. In some applications, it is necessary for the concrete to have high strength and heat resistance. Some example applications requiring high strength and/or heat resistance include runways and landing pads, anti-ballistic panels, and blast resistant walls, barriers, panels, and checkpoints. For instance, concrete pads used by vertical take-off and landing (VTOL) aircraft are subjected to extremely high temperatures during take-offs and landings. This increased heat may cause spalling in concrete used in runway construction. Spalling can occur when concrete is rapidly heated to a temperature above the boiling point of water, which may occur when VTOL aircraft hover over a particular area of concrete or during the transition to forward flight. At these times, VTOL aircraft produce extremely hot exhaust gases, which may cause moisture in the concrete to vaporize rapidly. The steam produced during this process causes an increase in pressure in the concrete, which may cause violent explosions.

Various methods for increasing concrete strength and/or heat resistance are known in the art. For instance, expanded perlite is a known concrete additive that produces a concrete that is lightweight and insulating, and thus has good heat resistance properties. Raw perlite is a naturally occurring siliceous rock having a relatively high water content. Expanded perlite is produced by rapidly heating raw perlite to a temperature above about 1600 degrees Fahrenheit. When perlite reaches this temperature, it softens and the water vaporizes and escapes. This process causes the perlite to expand greatly in volume. Raw perlite typically has a density of about 135 to about 150 pounds per cubic foot, while expanded perlite typically has a density of about 2 to about 8 pounds per cubic foot.

Adding perlite to a concrete mix gives the concrete excellent insulating properties, but perlite additives are not generally associated with high strength concrete. Perlite concretes typically have compressive strengths of about 1000 to 5000 psi after 28 days, though some perlite concretes have achieved compressive strengths in the range of about 5000 to 7000 psi after 28 days, according to the ASTM C39 standard test method for compressive strength of cylindrical concrete specimens. Producing concrete having similar insulating properties and a compressive strength greater than 8000 psi after 28 days typically requires expensive raw materials and/or complex processes.

Therefore, a need exists in the art for a concrete having excellent heat resistance and improved strength. Furthermore, a need exists in the art for a concrete having excellent heat resistance and improved strength that can be produced in a simple, cost-effective manner.

### SUMMARY

In accordance with the present invention, a high strength concrete composition having a compressive strength of at least about 8000 psi after 28 days is provided. The concrete composition additionally has excellent heat resistance and is resistant to spalling. Furthermore, the concrete composition has low permeability and thus has good resistance to water intrusion and chloride penetration, thereby resulting in a durable concrete composition.

The concrete composition of the present invention comprises the following materials, by weight: about 12 to about 40 percent cement, expanded perlite in an amount equal to about 4 to about 10 percent of the cement, up to about 45 percent coarse aggregate, about 25 to about 75 percent fine aggregate, water in an amount corresponding to a water to cement ratio of about 0.25 to about 0.35, and one or more chemical admixtures in an amount sufficient for workability. The expanded perlite preferably has a particle size less than about 200 microns. The chemical admixture(s) is selected from the group consisting of superplasticizers, sulfonated water reducers, polycarboxylate water reducers, and air entraining agents.

Before the chemical admixture is added to the composition, the composition is a relatively dry and thick mixture, which often appears to be lumpy, and is generally unworkable. Addition of the admixture provides enough workability such that the concrete can be set in place without the addition of water exceeding a water to cement ratio of about 0.35. The perlite additive combined with the very low water content of the concrete mix provides a concrete that is heat resistant, has low permeability, and has a compressive strength of at least about 8000 psi after 28 days. However, compressive strengths for the concrete of the present invention are consistently measured at greater than about 10000 psi after 28 days, and typically in the range of about 12000 to about 14000 psi after 28 days, with a maximum tested strength of about 16000 psi.

Accordingly, one object of the present invention is to provide a concrete having excellent heat resistance and improved strength. Furthermore, another object of the present invention is to provide a concrete having excellent heat resistance and improved strength that can be produced in a simple, cost-effective manner. These and other objects and advantages will become apparent from the following description.

### DESCRIPTION OF THE DRAWINGS

These and other features, aspects, and advantages of the present invention will become better understood with regard to the following description, appended claims, and accompanying drawing where:

FIG. 1 depicts a flow diagram of a method for producing a concrete composition embodying features of the present invention.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, ingredients, steps, etc. are optionally present. For example, an article “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The present invention comprises a novel high strength concrete composition and method of making the composition. The concrete composition is also extremely heat resistant and durable. These properties make the concrete composition suitable for a variety of purposes requiring very high strength and/or heat resistance. The composition of the present invention is particularly suitable for use in anti-ballistic panels, blast resistant walls, barriers, panels, and checkpoints, and runways and landing pads, particularly those used for vertical take-offs and landings.

The concrete composition comprises the following materials, by weight: about 12 to about 40 percent cement, expanded perlite in an amount equal to about 4 to about 10 percent of the cement, up to about 45 percent coarse aggregate, about 25 to about 75 percent fine aggregate, water in an amount corresponding to a water to cement ratio of about 0.25 to about 0.35, and one or more chemical admixtures in an amount sufficient for workability. The cement is preferably Portland cement, and the concrete composition may optionally comprise one or more supplementary cementitious materials, including, but not limited to, fly ash, ground granulated blast furnace slap, silica fume, and metakaolin. It should be understand that the water to cement ratio is determined by dividing the mass of water added to the composition by the combined mass of cement, perlite, and any supplementary cementitious materials.

The expanded perlite utilized in the present invention may be selected from a variety of commercially available perlite particles. In one embodiment, the Applicant prefers perlite particles produced by Carolina Perlite Company, Inc., located in Gold Hill, N.C. The expanded perlite preferably utilized in the present invention typically has a density of about 8 pounds per cubic foot. The expanded perlite particle size is preferably less than about 300 microns, and more preferably less than about 200 microns. In a preferred embodiment, the expanded perlite has a mean particle size in the range of about 10 microns to about 150 microns, and more preferably in the range of about 25 to about 50 microns. However, the particle size distribution may vary depending on the intended use, the method of production, and the supplier and still fall within the scope of the present invention. To produce the expanded perlite particles, raw perlite is crushed and then expanded by heating the crushed perlite to at least 1600 degrees Fahrenheit. Preferably, expanded perlite particles of a desired size distribution are then produced by separating the expanded perlite particles using sieves or any similar method known in the art. The particles are generally spherical in shape but have some rough edges or surfaces, which allows the cement to effectively bond to the particles and thus provides added strength. In alternative embodiments, the expanded perlite particles may be crushed or ground to achieve the desired particle size distribution, though these methods are not preferred because crushing or grinding the particles may alter the structure of the particles.

The addition of expanded perlite to the concrete composition provides an increase in long term strength, as well as a significant reduction in permeability. The reduction in permeability substantially reduces chloride penetration, which provides greater durability overall and particularly in marine or other salt environments. Furthermore, the reduction in permeability substantially reduces water intrusion such that freeze-thaw damage is virtually eliminated. The reduction of water intrusion also substantially reduces a source of water for potential spalling.

With respect to long term strength, typical perlite concretes have compressive strengths generally in the range of about 1000 to 5000 psi after 28 days, though some perlite concretes have achieved compressive strengths up to about 7000 psi after 28 days, thus providing a moderate increase in long term strength compared to a control composition of standard 5000 psi mix design. However, the perlite concrete of the present invention provides a concrete having a minimum strength of about 8000 psi after 28 days, and consistently produces concrete having a 28 day strength in the range of about 10000 to about 14000 psi, with a maximum tested 28 day strength of about 16000 psi. Compressive strength is determined according to the ASTM C39 standard test method for compressive strength of cylindrical concrete specimens.

In one embodiment, the concrete composition preferably comprises coarse aggregate up to about 45 percent by weight, though in other embodiments the addition of coarse aggregate is optional. Structural concrete typically requires at least a portion of coarse aggregate in order to provide adequate strength. However, due to the enhanced strength of the concrete composition of the present invention, 28 day compressive strengths in the range of about 10000 to about 14000 psi can be achieved without the use of coarse aggregate. In embodiments which include coarse aggregate, examples of suitable coarse aggregate that may be utilized include, but are not limited to, limestone, crushed gravel, crushed granite, and expanded shale. The coarse aggregate preferably has a size in the range of about ¼ inch to about ¾ inch, and more preferably in the range of about ¼ inch to about ½ inch.

The concrete composition further comprises fine aggregate in the range of about 25 percent to about 75 percent by weight, depending on whether coarse aggregate is used. In embodiments that do not include coarse aggregate, fine aggregate may be used to at least partially replace the coarse aggregate. In a preferred embodiment, the total amount of aggregate, including both fine aggregate and coarse aggregate (if present), is in the range of about 40 percent to about 75 percent of the concrete composition by weight. The fine aggregate preferably comprises sand, but may also comprise other materials such as copper slag, coal bottom ash, or similar materials.

The concrete composition further comprises water in an amount corresponding to a water to cement ratio in the range of about 0.25 to about 0.35. Preferably, the ratio is in the range of about 0.25 to about 0.30. Because the addition of water decreases the strength of the concrete, it is critical to the present invention that the amount of water added to the composition is kept to a minimum. Furthermore, it is critical that no additional water is added to the concrete mix on site during placement of the concrete. The low water content of the concrete has the added benefit of substantially reducing the potential for spalling due to a reduced amount of residual moisture in the composition.

The composition further comprises one or more chemical admixtures. The chemical admixture(s) must be added to the composition in order to provide workability for placing the concrete. Before a chemical admixture is added to the composition, the composition is a relatively dry and thick mixture, which often appears to be lumpy, and is generally unworkable. Addition of a sufficient amount of one or more chemical admixtures provides enough workability such that the concrete can be set in place without the need to add water in an amount exceeding a water to cement ratio of about 0.35.

The chemical admixture(s) is preferably selected from the group consisting of superplasticizers, sulfonated water reducers, polycarboxylate water reducers, and air entraining agents. The most effective chemical admixtures for providing workability are water reducers and superplasticizers, also referred to as high range water reducers. Thus, in a preferred embodiment, one or more superplasticizers, sulfonated water reducers, or polycarboxylate water reducers are added to the concrete mix. Superplasticizers or water reducers for increasing workability may be selected from a variety of commercially available products. In a one embodiment, the Applicant prefers the following chemical admixtures for increasing workability of the concrete mix: ADVA 140M, ADVA 190, ADVA 370, ADVA Cast 555, and Daracem 100, each of which is produced by W. R. Grace & Co. ADVA 140M, ADVA 190, ADVA 370, and ADVA Cast 555 are polycarboxylate-based high range water reducers that are added to the concrete mix generally in the range of about 8-20 fluid ounces per 100 pounds cementitious material. Daracem 100 is another preferred high range water reducer. Daracem 100 is typically added in somewhat smaller quantities, preferably in the range of about 5-10 fluid ounces per 100 pounds cementitious material. It should be understood that any chemical admixture suitable for providing workability without the need for adding water to the concrete mix in an amount exceeding a water to cement ratio of about 0.35 falls within the scope of the present invention. It should be further understood that the amounts added to a particular concrete mix may be varied and still fall within the scope of the present invention. The amount added to a particular mix will depend on a variety of factors, including ambient temperature, humidity, wind speed, and time between batching and placing the concrete mix, among other factors. Thus, the quantities of superplasticizers and water reducers added to a particular batch should be determined according to the specific conditions and requirements for each particular concrete mix.

Additionally, an air entraining agent may optionally be added to the concrete mix. Air entraining agents provide added durability while also increasing workability. However, air entraining agents negatively effect compressive strength and thus should only be used in relatively small quantities as a complementary chemical admixture in conjunction with superplasticizers and/or water reducers. An example of a suitable, commercial available air entraining agent is Daravair 1000, produced by W. R. Grace & Co.

The following examples of concrete mixes produced by the Applicant illustrate exemplary embodiments of the present invention.

### Example 1

This concrete mix contained the following ingredients: 820 pounds of Portland cement, 205 pounds of fly ash, 66.4 pounds of expanded perlite, 984 pounds of coarse aggregate, 820 pounds of sand, 367 pounds of water, and 238 fluid ounces of ADVA 140M superplasticizer. The particle size of the expanded perlite ranged from about 10 to about 100 microns, with a mean particle size of about 35 microns. The water to cement ratio was about 0.33. This concrete mix had a compressive strength of about 12460 psi after 28 days and a flexural strength of about 1275 psi.

### Example 2

This concrete mix was formulated with no coarse aggregate. The mix contained the following ingredients: 850 pounds of Portland cement, 250 pounds of silica fume, 60 pounds of expanded perlite, 1321 pounds of sand, 321 pounds of water, 160 fluid ounces of ADVA 370 superplasticizer, and 160 fluid ounces of Daracem 100 superplasticizer. The weight of this concrete mix was 2910 pounds per cubic yard, and the water to cement ratio was about 0.27. This concrete mix had a compressive strength of about 14610 psi after 28 days.

### Example 3

This concrete mix contained the following ingredients: 900 pounds of Portland cement, 250 pounds of silica fume, 60 pounds of expanded perlite, 1297 pounds of coarse aggregate, 854 pounds of sand, 314 pounds of water, 14 pounds of ADVA 370 superplasticizer, and 11 pounds of Daracem 100 superplasticizer. The water to cement ratio was about 0.26. This concrete mix had a compressive strength of about 16300 psi after 28 days. In this particular embodiment, it is necessary to keep the water to cement ratio at or below about 0.27 in order to achieve a compressive strength of about 16000 psi or higher after 28 days.

A specimen was taken from each of the three example mixes, respectively. Each specimen was heated using a MAPP gas torch for about 10 minutes. The tip of the torch was held about 2 inches from the surface of each specimen, with a flame temperature greater than 5000 degrees Fahrenheit. Each of the specimens exhibited a red glow, but no spalling was observed.

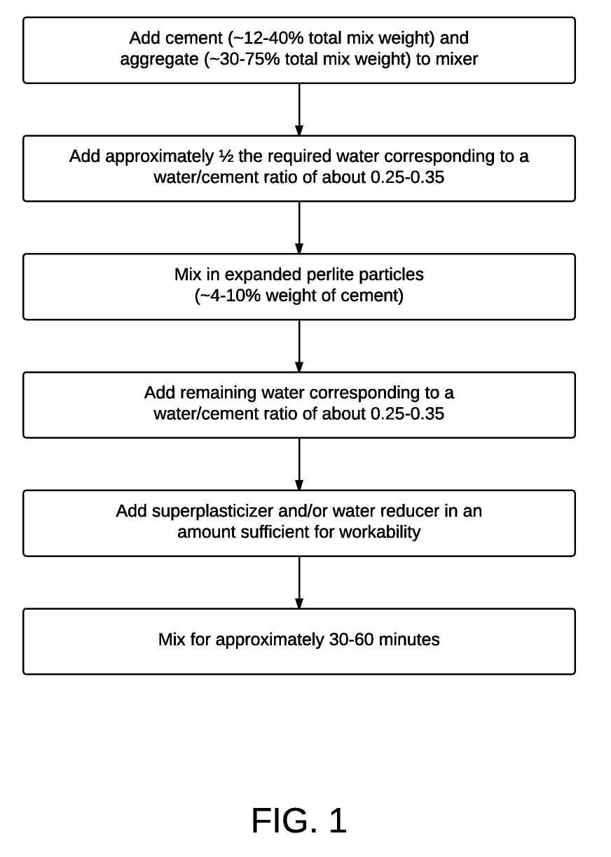

The examples set forth above were batched and set in place according to the following method, as illustrated in FIG. 1. First, the cement and all aggregate, including fine aggregate and coarse aggregate, are added to a mixer. In a preferred embodiment, the mixer is a ribbon blade mixer. Next, about half of the total amount of water is added to the composition. The total amount of water added should be in a water to cement ratio ranging from about 0.25 to about 0.35. The expanded perlite particles are then added to the composition. The composition is mixed until the perlite is substantially distributed throughout the mixture. The remainder of the water is then added to the mixture.

In an alternative embodiment, a slurry of expanded perlite particles in water is formed first and then added to the mixture of cement and aggregate. The composition of the slurry should be about 80 percent to about 90 percent water and about 10 percent to about 20 percent perlite. The slurry facilitates the mixing of the perlite into the composition and also aids in reducing dust formed by the perlite particles during the mixing process. In this embodiment, it should be understood that the water contained in the slurry should be used when calculating the water to cement ratio. Further, a perlite slurry comprising about 80 percent to about 90 percent water typically accounts for most of the required water to be added to the concrete composition.

The final ingredient added to the concrete composition is at least one chemical admixture for providing workability. The chemical admixture is preferably a superplasticizer, water reducer, or similar material suitable for providing workability without exceeding a water to cement ratio of about 0.35. Before the chemical admixture is added to the composition, the composition is a relatively dry and thick mixture, which often appears to be lumpy. At this point in the mixing process, the composition appears to be generally unworkable such that more water should be added to produce a workable concrete mix. After the chemical admixture is added, the concrete mix should be mixed for about 10 to about 60 minutes. The composition of the present invention is typically mixed substantially longer compared to a more typical mixing time of 10-20 minutes. Due to a longer typical mixing time, a retarder may optionally be added to the composition in order to slow the hydration of the concrete mix. Even after the addition of the admixture, the concrete mix will have a relatively low slump value, but should have enough workability such that the concrete mix can be set in place.

The concrete mix is then poured, preferably using a progressive cavity pump. Due to the relatively low slump value, an internal concrete vibrator should be used to aid in setting the concrete mix. The vibrator will cause the mix to flow more freely into any corners or other gaps where the mix is not smoothly and uniformly distributed. In a preferred embodiment, a variable speed internal vibrator is used in setting the concrete mix. Individual batches of concrete mix made according to the present invention may have varying slump values, and thus the use of a variable speed vibrator will allow the operator to adjust the vibration as necessary for the individual mix being placed.

Concrete compositions produced in accordance with the present invention have a number of enhanced properties relative to other known concrete compositions. The concrete composition exhibits a combination of very high compressive strength, excellent heat resistance, and low permeability. In particular, the composition exhibits substantially higher compressive strength compared to standard 5000 psi mix concrete, sometimes greater than three times the compressive strength of regular concrete. The result is a composition that is durable and also extremely strong. In some embodiments, a 28 day strength of about 12000 to about 14000 psi can be achieved without the addition of coarse aggregate, which provides for a simplified production process which may utilize sand as the only aggregate.

In addition, the composition is resistant to spalling even when exposed to extremely high temperatures. The very low water to cement ratio results in a concrete composition with very little excess moisture that could potentially cause spalling. Furthermore, the low permeability of the concrete allows very little water intrusion, which also limits the potential for spalling. These properties, combined with the insulating properties of the expanded perlite, produce a concrete that is extremely resistant to spalling, thereby making the composition very useful in high temperature applications such as runways and landing pads used by VTOL aircraft. Similarly, the composition can also greatly reduce heat island effect in urban, airport, and industrial settings.

Additionally, due to the enhanced strength of the composition, the concrete composition is particularly useful in anti-ballistic panels, blast resistant walls, barriers, panels, and checkpoints, and similar applications in which the concrete is subjected to extreme forces. Furthermore, the enhanced strength of the composition allows lesser quantities of concrete to be used in the construction of highway, bridges, buildings, dams, and similar structures, thereby reducing costs.

It is understood that versions of the invention may come in different forms and embodiments. Additionally, it is understood that one of skill in the art would appreciate these various forms and embodiments as falling within the scope of the invention as disclosed herein.

What is claimed is:

1. A concrete composition, comprising:
a. about 12 to about 40 percent cement by weight;
b. expanded perlite in an amount equal to about 4 to about 10 percent of said cement by weight, said expanded perlite having a particle size less than about 200 microns;
c. up to about 45 percent coarse aggregate by weight;
d. about 25 to about 75 percent fine aggregate by weight;
e. water in an amount corresponding to a water to cement ratio of about 0.25 to about 0.35 by weight; and,
f. one or more chemical admixtures in an amount sufficient for workability.

2. The concrete composition of claim 1, wherein the water to cement ratio is in the range of about 0.25 to about 0.30 by weight.

3. The concrete composition of claim 1, wherein the compressive strength of the composition is at least 8000 psi after 28 days.

4. The concrete composition of claim 1, wherein the compressive strength of the composition is at least 12000 psi after 28 days.

5. The concrete composition of claim 1, wherein the mean particle size of the expanded perlite is about 25 microns to about 50 microns.

6. The concrete composition of claim 1, wherein the one or more chemical admixtures is selected from the group consisting of superplasticizers, sulfonated water reducers, and polycarboxylate water reducers.

7. The concrete composition of claim 1, further comprising an air entraining agent.

8. The concrete composition of claim 1, wherein the coarse aggregate comprises one or more aggregates from the group consisting of limestone, crushed gravel, crushed granite, and expanded shale.

9. The concrete composition of claim 1, wherein the fine aggregate comprises sand.

10. The concrete composition of claim 1, wherein the about 12 to about 40 percent cement by weight further comprises one or more supplementary cementitious materials selected from the group consisting of fly ash, ground granulated blast furnace slap, silica fume, and metakaolin.

11. The concrete composition of claim 1, further comprising a retarder.

12. A method of producing a concrete composition, said method comprising the following steps:
a. combining a quantity of cement with a quantity of aggregate, said quantity of cement equal to about 12 to about 40 percent of the concrete composition by weight, said quantity of aggregate equal to about 40 to about 75 percent of the concrete composition by weight;
b. adding water in an amount corresponding to a water to cement ratio of about 0.25 to about 0.35 by weight;
c. adding expanded perlite in an amount equal to about 4 to about 10 percent of said cement by weight, said expanded perlite having a particle size less than about 200 microns;
d. adding one or more chemical admixtures in an amount sufficient for workability; and,
e. mixing the composition for approximately 10 to 60 minutes.

13. The method of claim 12, wherein approximately half of the water is added to the composition before the addition of the expanded perlite and the other approximately half of the water is added to the composition after the addition of the expanded perlite.

14. The method of claim 12, further comprising the step of adding a retarder.

15. The method of claim 12, wherein the aggregate comprises a quantity of coarse aggregate up to about 45 percent of the concrete composition by weight and a quantity of fine aggregate about 25 to about 75 percent of the concrete composition by weight.

16. The method of claim 12, further comprising the steps of setting the concrete composition in place for hardening and applying a variable speed internal vibrator to the concrete composition while the composition is setting.

17. The method of claim 12, wherein the about 12 to about 40 percent cement by weight further comprises one or more supplementary cementitious materials selected from the group consisting of fly ash, ground granulated blast furnace slap, silica fume, and metakaolin.

18. The method of claim 12, wherein the one or more chemical admixtures is selected from the group consisting of superplasticizers, sulfonated water reducers, and polycarboxylate water reducers.

19. The method of claim 12, wherein the compressive strength of the composition is at least 12000 psi after 28 days.

20. The method of claim 12, wherein the water and the expanded perlite are mixed together to form a slurry before being added to the composition.
